(19) United States
(12) Patent Application Publication
(10) Pub. No.: US 2023/0317954 A1
(43) Pub. Date: Oct. 5, 2023

(54) ELECTRODE FOR SECONDARY BATTERY, METHOD OF MANUFACTURING THE SAME, AND SECONDARY BATTERY COMPRISING THE SAME

(71) Applicant: SK ON CO., LTD., Seoul (KR)

(72) Inventors: Dong Hoon LEE, Daejeon (KR); Min Hwan KIM, Daejeon (KR); Jae Seong LEE, Daejeon (KR)

(21) Appl. No.: 18/194,858

(22) Filed: Apr. 3, 2023

(30) Foreign Application Priority Data
Apr. 4, 2022 (KR) 10-2022-0041589

(51) Int. Cl. H01M 4/62; H01M 4/04

(52) U.S. Cl. CPC H01M 4/622; H01M 4/0404; H01M 2004/027

(57) ABSTRACT

Provided are an electrode for a secondary battery, a method of manufacturing the same, and a secondary battery comprising the same. In some embodiments of the disclosed technology, an electrode for a secondary battery includes a current collector, and an electrode active material layer located on at least one surface of the current collector, the electrode active material layer satisfies the following relational expression: 1.0≤Bₑᵢ/B_{ci}≤2.0, wherein B_{ci} is an interfacial binder content of a center portion of the electrode active material layer in a width direction of the electrode active material layer, and Bₑᵢ is an interfacial binder content of a side portion of the electrode active material in the width direction of the electrode active material layer.

### CROSS-REFERENCE TO RELATED APPLICATIONS

This application claims priority under 35 U.S.C. § 119 to Korean Patent Application No. 10-2022-0041589, filed on Apr. 4, 2022, in the Korean Intellectual Property Office, the disclosure of which is incorporated herein by reference in its entirety.

### TECHNICAL FIELD

The disclosed technology generally relates to an electrode for a secondary battery, a method of manufacturing an electrode for a secondary battery, and a secondary battery comprising an electrode.

### BACKGROUND

As emission standards for vehicles become more stringent, the electric vehicle (EV) market and the secondary battery market are growing rapidly. Different from gas vehicles, however, fueling electric vehicles, in other words, recharging the battery pack in the electric vehicles can take up to 6 to 7 hours to complete when 7 kW electric slow charging method is used.

### SUMMARY

The disclosed technology can be implemented in some embodiments to increase the productivity of an electrode by lowering a binder content in the electrode and optimize a binder distribution in the electrode. In this way, it is possible to reduce or minimize a side ring that otherwise would have occurred during an electrode manufacturing process while improving rapid charging performance of a secondary battery.

In one general aspect, an electrode for a secondary battery includes: a current collector; and an electrode active material layer located on at least one surface of the current collector, in which the following relational expression 1 is satisfied.

1.0≤Bₑᵢ/B_{ci}≤2.0 [Relational Expression 1]

In Relational Expression 1, B_{ci} is an interfacial binder content of a center portion of the electrode active material layer in a width direction, and Bₑᵢ is an interfacial binder content of a side portion of the electrode active material layer in the width direction.

The following relational expression 2 may be further satisfied.

2.5≤Bₑᵢ/Bₑₛ≤5.0 [Relational Expression 2]

In Relational Expression 2, Bₑₛ is a surface binder content of the side portion of the electrode active material layer in the width direction, and Bₑᵢ is the interfacial binder content of the side portion of the electrode active material layer in the width direction.

The electrode active material layer may include 0.1 to 2 wt % of binder based on a total weight of the electrode active material layer.

The electrode active material layer may include a styrene butadiene rubber-based binder.

The electrode may include an anode.

A protruding height of the side portion of the electrode active material layer in the width direction may be 0 μm or less.

In another aspect, a method of manufacturing an electrode for a secondary battery includes: a) applying a binder suspension to at least one surface of a current collector; b) drying a side portion of the current collector to which the binder suspension is applied; c) applying electrode slurry containing an electrode active material on the binder suspension; and d) drying a resultant of step c).

In the step a), the binder suspension may be uniformly applied to at least one surface of the current collector.

In step a), a thickness of the applied binder suspension may be 0.1 to 10 μm.

The binder suspension applied in step a) may include 5 to 50 wt % of the binder based on a total weight of the binder suspension, and the electrode slurry applied in step c) may include a binder in an amount of 2.0 wt % or less based on the total weight of the electrode slurry.

Step b) may be performed for 0.001 to 5 seconds at a temperature of 120 to 600° C.

Step d) may be performed for 10 to 300 seconds at a temperature of 50 to 300° C.

A secondary battery, comprising: the electrode of any one of claims 1 to 6.

In still another aspect, a secondary battery may include the electrode implemented based on some embodiments of the disclosed technology.

### BRIEF DESCRIPTION OF DRAWINGS

FIG. 1 is a perspective view of an electrode based on some embodiments of the disclosed technology.

FIG. 2A is a plan view of the electrode of FIG. 1 viewed in a z-axis direction.

FIG. 2B is a cross-sectional view of the electrode of FIG. 1 taken along line I-I′.

FIG. 3 is a diagram for describing a method of measuring a protruding height of a side portion of an electrode active material layer in a width direction.

FIG. 4 is a graph reflecting results of Energy Dispersive X-ray Spectroscopy (EDS) analysis for evaluating a binder distribution in a thickness direction according to whether to dry the side portion of the electrode.

FIGS. 5A to 5C are diagrams illustrating EDS mapping images for evaluating a binder distribution in the thickness direction according to whether to dry the side portion.

FIG. 5A is a diagram illustrating an EDS mapping image measuring an interfacial binder content in a center portion of the electrode.

FIG. 5B is a diagram illustrating an EDS mapping image in which an interfacial binder content at a side portion of Comparative Example 1 is measured.

FIG. 5C is a diagram illustrating an EDS mapping image in which an interfacial binder content at a side portion of Example 1 is measured.

FIG. 6A is a diagram illustrating a 3D image of a cross section of an anode in a width direction according to Example 1 analyzed by confocal microscopy.

FIG. 6B is a diagram illustrating a 3D image of a cross section of an anode in a width direction according to Comparative Example 1 by confocal microscopy.

### DETAILED DESCRIPTION OF EMBODIMENTS

Advantages and features of the disclosed technology disclosed in this patent document are described by example embodiments with reference to the accompanying drawings.

In some implementations, secondary batteries can improve rapid charging performance by reducing a binder content, which can be accomplished by a binder having high adhesion. However, when the binder content is not sufficient, an electrode active material layer may be detached from a current collector during a notching process or a charging/discharging process.

In some implementations, the binder is efficiently distributed inside the electrode. In one example, electrode slurry having a high binder content is formed in a lower layer and electrode slurry having a low binder content is applied to an upper layer on a current collector as a dual layer. In this case, the high binder content is formed at an interface between the current collector and the electrode active material layer, and thus it is possible to lower the binder content in the entire electrode active material layer while suppressing the detachment of the active material layer, thereby improving battery performance. However, when forming the electrode slurry as the dual layer, it is difficult to lower a thickness of the lower layer to a certain level and thus it is difficult to dramatically lower the binder content.

In some implementations, a binder suspension is formed on the current collector as a thin film primer layer and then the electrode slurry is formed on a liquid binder suspension primer layer to efficiently distribute the binder in the electrode active material layer. In some implementations, the electrode active material layer, by sequentially applying such a binder suspension-electrode slurry, may form a thicker electrode slurry having a lower binder content compared to the above-described dual-layer coating, and thus the binder content in the electrode active material layer may be greatly reduced, thereby greatly increasing the resistance and rapid charging performance of the battery.

However, when the electrode slurry is applied to an upper portion of the liquid binder suspension, the liquid binder suspension with fluidity may be pushed due to a high discharge pressure, and, accordingly, it is difficult to maintain the binder distribution uniformly and a side portion of the electrode may be coated thicker than a center portion to form a protruding side ring. In addition, there may be various electrode quality issues, such as uneven distribution of binder composition at the side portion and center portion of the electrode, irregularity in electrode coating width, and dewetting due to a flow of electrode slurry, thereby lowering the productivity of the electrode. In particular, when the side ring phenomenon is severe, the current collector may be torn during the electrode manufacturing process, or the electrode active material layer is dented by a rolling roll during rolling.

In addition, the electrode active material layer formed by sequentially applying the binder suspension-electrode slurry may lower the resistance and improve the electrode performance, reducing the total binder content in the electrode. However, as the binder content is reduced, peeling of the electrode active material layer may still occur due to insufficient adhesion between the current collector and the electrode active material layer.

The disclosed technology can be implemented in some embodiments to provide an electrode that can address the issues discussed above, such as the side rings and the peeling between the current collector and the electrode active material layer that can occur during the electrode manufacturing process. The disclosed technology can also be implemented in some embodiments to improve the rapid charging performance by optimizing the binder distribution in the electrode and reducing the total binder content.

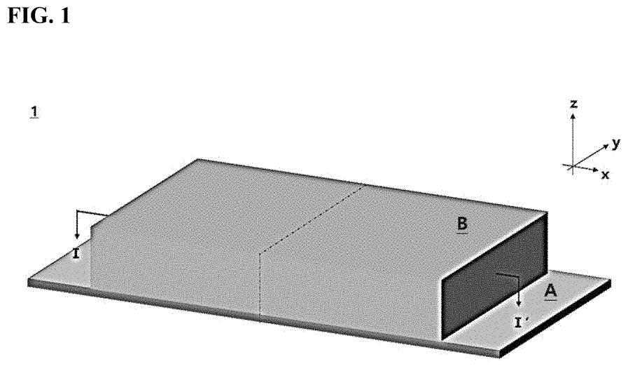

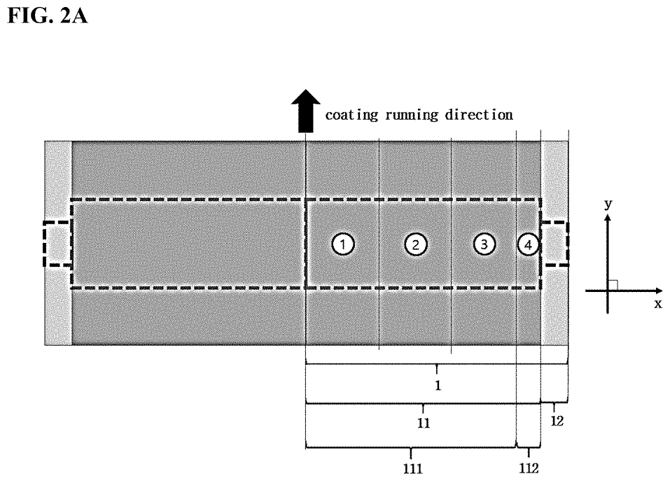

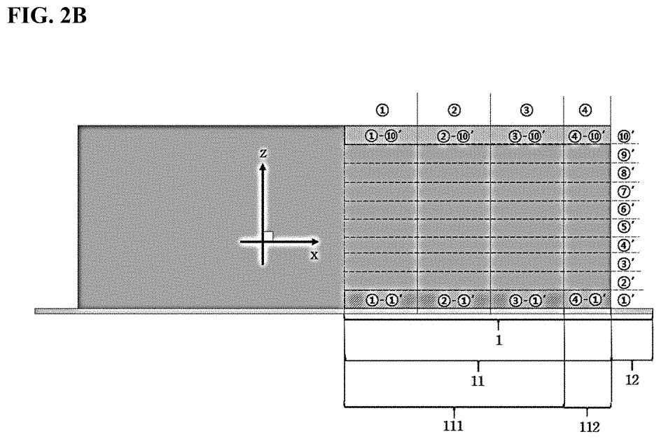

FIG. 1 is a perspective view of an electrode 1 comprising a current collector (A) and an electrode active material layer (B) based on some embodiments of the disclosed technology. FIG. 2A is a plan view of the electrode of FIG. 1 viewed in a z-axis direction, and FIG. 2B is a cross-sectional view of the electrode of FIG. 1 taken along line I-I′. A region indicated by a dotted line in FIG. 2A may refer to a part that becomes an electrode when assembling a battery later.

Referring to FIGS. 1 and 2A, in some implementations, the term “side portion” can be used to indicate an end portion 112 of an electrode coated part 11 in a width direction toward an electrode uncoated part 12 side of an electrode 1 when a direction horizontal to a coating running direction of the electrode is called a longitudinal direction (y-axis direction), and a direction perpendicular to the coating running direction is called a width direction (x-axis direction) during the electrode manufacturing process. In some implementations of the disclosed technology, the width of the side portion 112 may refer to a width of 20% or less based on the total width of the electrode coated part 11 in the width direction. In addition, in some implementations, the term “center portion” refers to a region 111 excluding the side portion 112 based on the width direction in the electrode coated part 11. In some implementations, the region 111 includes a center portion.

Referring to FIGS. 1 and 2B, in some implementations, the “interfacial binder content” refers to an average binder content in one section (\textcircled{1}′) in a thickness direction from an interface between a current collector and an electrode active material layer to the electrode active material layer when a cross section (I-I′ cross section) of the electrode active material layer in the thickness Text use direction from the surface of the electrode to the current collector is divided into 10 sections (\textcircled{1}′ to [symbol] ′) with the same thickness. In other words, the “interfacial binder content” refers to the average binder content in the thickness 10% region (\textcircled{1}′) based on the total thickness of the electrode active material layer in the thickness direction from the interface between the current collector and the electrode active material layer to the electrode active material layer.

In addition, the “surface binder content” refers to an average binder content in one section ( [symbol] ′) in the thickness direction from the surface of the electrode to the electrode active material layer when the cross section (I-I′ cross section) of the electrode active material layer in the thickness direction from the surface of the electrode to the current collector divided into 10 sections (\textcircled{1}′ to [symbol] ′) with the same thickness. In other words, the “surface binder content” refers to the average binder content in the thickness 10% region ( [symbol] ′) based on the total thickness of the electrode active material layer in the thickness direction from the surface of the electrode to the electrode active material layer.

In addition, in some implementations, the binder content may be a value derived after normalizing the average binder content to 1 in the thickness 30% region (\textcircled{8}′ to [symbol] ′) based on the total thickness of the electrode active material layer in the thickness direction from the surface of the electrode to the electrode active material layer. The content of the binder before normalized is, for example, wt %, or, for example, when a styrene butadiene rubber (SBR)-based binder is used as a binder, the content of the binder may be derived as the content (at %) of the adsorbed Os element after exposing the electrode to Os gas. However, the disclosed technology is not limited to the Os element and may be an element capable of representing the binder depending on the type of the binder.

It goes without saying that the definition of the above-described “side portion”, “center portion”, “interfacial binder content”, “surface binder content”, binder content, etc., is applied to the electrode during coating running in the electrode assembly process, and as illustrated in FIG. 2A, the same applies to the part that becomes the electrode when assembling the battery later. For example, for the already assembled battery, after disassembling the battery, each side portion, center portion, binder content, etc., can be defined based on the descriptions of the above-described FIGS. 1, 2A, 2B and terms for the obtained electrode.

Based on some embodiments of the disclosed technology, an electrode for a secondary battery includes a current collector, and an electrode active material layer located on at least one surface of the current collector, and satisfies the following relational expression 1.

1.0≤Bₑᵢ/B_{ci}≤2.0 [Relational Expression 1]

In Relational Expression 1, B_{ci} is a content of an interfacial binder of a central portion of the electrode active material layer in a width direction, and Bₑᵢ is a content of an interfacial binder of a side portion of the electrode active material layer in the width direction.

Referring to FIGS. 2A and 2B, the interfacial binder content B_{ci} of the center portion refers to an average value of the interfacial binder contents measured at a center (\textcircled{1}-\textcircled{1}′, \textcircled{2}-\textcircled{1}′, and \textcircled{3}-\textcircled{1}′) of an area in which the center portion is divided into 3 equal parts based on the width direction, and the interfacial binder content Bₑᵢ of the side portion refers to an average value of the interfacial binder content measured at the center (\textcircled{4}-\textcircled{1}′) of the side portion.

In the electrode for a secondary battery that satisfies the above-described Relational Expression 1, the interfacial binder content Bₑᵢ of the side portion is higher than the interfacial binder content B_{ci} of the center portion, so an interfacial adhesive force of the side portion compared to the center portion is increased. Accordingly, it is possible to suppress peeling of the electrode active material layer by effectively supporting a stress that may occur between the current collector and the electrode active material layer during the battery assembly process and the charging/discharging process.

From the viewpoint of further suppressing the peeling of the electrode active material layer, the electrode for a secondary battery that satisfies the above-described Relational Expression 1 may have Bₑᵢ/B_{ci} of, for example, greater than 1.0, for example, 1.05 or more, or, for example, 1.1 or more.

However, when the Bₑᵢ/B_{ci} value is too high, the imbalance of the interfacial binder content and the surface binder content in the center portion and the side portion is severe, so, during the notching process, detachment of the electrode active material layer may occur in the form of particles from the surface of the electrode active material layer rather than the peeling at the boundary between the current collector and the electrode active material layer. In addition, there is a risk that cracks may occur during the drying process due to the insufficient surface binder content of the side portion during the drying process. In consideration of the above problem, Bₑᵢ/B_{ci} may be, for example, 2.0 or less, or, for example, 1.6 or less, or, for example, 1.4 or less.

In consideration of the above-described effect, Bₑᵢ/B_{ci} may satisfy at least one of the following inequalities. 1.0<Bₑᵢ/B_{ci}≤2.0, or 1.05≤Bₑᵢ/B_{ci}≤2.0, or 1.1≤Bₑᵢ/B_{ci}≤2.0, or 1.0<Bₑᵢ/B_{ci}≤1.6, or 1.05≤Bₑᵢ/B_{c}≤1.6, or 1.1≤Bₑᵢ/B_{ci}≤1.6, or 1.0<Bₑᵢ/B_{ci}≤1.4, or 1.05≤Bₑᵢ/B_{ci}≤1.4, or 1.1≤Bₑᵢ/B_{ci}≤1.4.

The electrode may further satisfy Relational Expression 2 below.

2.5≤B_{ci}/Bₑₛ≤5.0 [Relational Expression 2]

In Relational Expression 2, Bₑₛ is a content of a surface binder of the side portion of the electrode active material layer in the width direction, and Bₑᵢ is the content of the interfacial binder of the side portion of the electrode active material layer in the width direction.

Referring to FIGS. 2A and 2B, the surface binder content Bₑₛ of the side portion of Relational Expression 2 refers to an average value of the surface binder contents measured at the center (\textcircled{4}- [symbol] ′) of the side portion, and the interfacial binder content Bₑᵢ of the side portion of Relational Expression 2 refers to an average value of the interfacial binder contents measured at the center (\textcircled{4}-\textcircled{1}′) of the side portion.

In the electrode for secondary battery that further satisfies the above-described Relational Expression 2, the interfacial binder content Bₑᵢ of the side portion is higher than the surface binder content Bₑₛ, so the detachment of the electrode active material layer of the side portion may be further suppressed. In the viewpoint of securing such an effect, Bₑᵢ/Bₑₛ may be, for example, 2.5 or more, or, for example, 2.75 or more, or, for example, 3.0 or more.

However, when the Bₑᵢ/Bₑₛ value is too high, not only the effect of suppressing the detachment of the electrode active material layer is saturated, but also since the surface binder content is too low, the detachment occurs in particles or dust form due to cracking of the electrode active material near the surface of the electrode active material layer during the notching process, so there is a risk of safety problems with the assembled secondary battery. In consideration of the above problem, Bₑᵢ/Bₑₛ may be, for example, 5.0 or less, or, for example, 4.5 or less, or, for example, 4.0 or less.

In consideration of the above-described effect, Bₑᵢ/Bₑₛ may satisfy at least one of the following inequalities. 2.5≤Bₑᵢ/Bₑₛ≤5.0, 2.75≤Bₑᵢ/Bₑₛ≤5.0, 3.0≤Bₑᵢ/Bₑₛ≤5.0, 2.5≤Bₑᵢ/Bₑₛ≤4.5, 2.75≤Bₑᵢ/Bₑₛ≤4.5, 3.0≤Bₑᵢ/Bₑₛ≤4.5, 2.5≤Bₑᵢ/Bₑₛ≤4.0, 2.75≤Bₑᵢ/Bₑₛ≤4.0, or 3.0≤Bₑᵢ/Bₑₛ≤4.0.

The electrode active material layer may include 0.1 to 2 wt %, or 0.1 to 1.8 wt %, or 0.5 to 1.8 wt %, or 0.5 to 1.5 wt % of binder based on the total weight of the electrode active material layer. In some embodiments of the disclosed technology, by densely distributing the binder at the interface between the current collector and the electrode active material layer and reducing the binder content toward the electrode surface, the total amount of the binder included in the entire active material layer may be significantly reduced. Accordingly, it is possible to improve the adhesion between the current collector-electrode active material layer and improve the rapid charging performance.

The electrode active material layer may be formed by applying a binder suspension to at least one surface of the current collector, drying a side portion of the current collector, to which the binder suspension is applied, in the width direction, and then drying a resultant obtained by applying the electrode slurry containing the electrode active material on the binder suspension. However, it should be noted that this is an example for forming the above-described electrode active material layer, and the electrode active material layer according to the disclosed technology may be formed by various methods.

Hereinafter, the binder suspension, the current collector, and the electrode slurry will be described in detail.

The binder suspension may include 5 to 50 wt %, 10 to 50 wt %, 15 to 50 wt %, 10 to 40 wt %, 15 to 40 wt %, 5 to 30 wt %, 10 to 30 wt %, or 15 to 30 wt % of binder based on the total weight of the binder suspension. The binder suspension contains a relatively large amount of binder compared to the electrode slurry containing a large amount of the electrode active material, and therefore, is applied on the current collector to further increase the adhesion between the current collector and the electrode active material layer.

The binder may include a styrene-butadiene rubber (SBR)-based binder, for example, styrene-butyl rubber, a styrene-butyl acrylate copolymer, etc., but the disclosed technology is not limited thereto.

In the case of using the SBR-based binder or the like, the viscosity of the binder suspension is very low because the binder is mixed in the form of particles. In addition, since the size of the binder particles is a small size of 200 nm or less, when the electrode slurry is applied on the binder suspension and then dried, the binder particles into the electrode slurry located on the upper portion are easily migrated by osmotic pressure, so even after drying, a distinct binder layer may not be formed between the binder suspension and the electrode slurry. In addition, the SBR-based binder has good spreadability with the current collector, and therefore, may be uniformly applied to a relatively thin thickness without forming a separate pattern in the width direction of the current collector, thereby further improving the adhesion between the current collector and the electrode active material layer.

On the other hand, unlike the SBR-based binder, polyacrylic acid (PAA), polyvinylidene fluoride (PVDF), carboxymethyl cellulose (CMC), etc. that may be used as an electrode binder in addition to the SBR-based binder are applied in a state of being dissolved in a solvent, and when the electrode is dried, the solvent is sufficiently dried, and then the phase is separated to form a binder layer. For this reason, binders such as the polyacrylic acid are not easily migrated into the upper electrode active material layer during the drying process, and furthermore, there is a risk of increasing the interfacial specific resistance by forming a distinct binder layer between the current collector and the active material layer. In addition, there is a problem in that the pattern is not uniformly distributed in the width direction of the current collector (e.g., island type, dot type). As a result, the adhesion and interfacial specific resistance between the current collector and the electrode active material layer are poor. In consideration of this, the binder suspension may contain or may not contain at least one of polyacrylic acid (PAA), polyvinylidene fluoride (PVDF), and carboxymethyl cellulose (CMC) in amount of 5 wt % or less, 4 wt % or less, or 3 wt % or less based on the total weight of the binder in the binder suspension.

The binder suspension may be prepared including a binder and a solvent. The binder suspension refers to a mixture in which the binders are not dissolved and exist in the form of particles in a solvent, and if necessary, a thickener, a conductive material, and the like may be additionally mixed and used.

The solvent for the anode may be at least one selected from the group consisting of water, pure water, deionized water, distilled water, ethanol, isopropanol, methanol, acetone, n-propanol, and t-butanol, but is not limited thereto.

When the thickener is added, it may stabilize a solution by imparting viscosity to the binder suspension. As an example of the thickener, a cellulose-based compound, and specifically, one or more of carboxymethyl cellulose, hydroxypropylmethyl cellulose, methyl cellulose, alkali metal salts thereof, or the like may be mixed and used. As the alkali metal, Na, K, or Li may be used.

The conductive material is used to impart conductivity to the electrode, and is not particularly limited as long as it is a conventional electronically conductive material that does not cause chemical change in the battery. For example, those selected from the group consisting of natural graphite, artificial graphite, carbon black, acetylene black, ketjen black, carbon fibers, carbon nanotubes, and combinations thereof may be used, but are not limited thereto.

The viscosity of the binder suspension may be 1 to 10,000 cps, or 5 to 5,000 cps, or 10 to 2,000 cps. When the binder suspension having the above viscosity is used, the binder suspension may be uniformly applied on the current collector, and the binder particles may be well migrated upward during the drying process.

As the current collector, those selected from the group consisting of copper foil, nickel foil, stainless steel foil, titanium foil, nickel foam, copper foam, a polymer substrate coated with a conductive metal, and combinations thereof may be used, but are not limited thereto.

The electrode slurry may include 90 wt % or more, 90 to 99.5 wt %, or 95 to 99.5 wt % of the electrode active material, include or may not include 2.0 wt % or less, 1.5 wt % or less, or 1.0 wt % or less of the binder, and include the conductive material and thickener as the balance, based on the total weight of the electrode slurry. Even if the binder content of the electrode slurry is prepared to be low, the adhesion between the current collector and the electrode active material layer may be increased by the migration of binder particles when the binder suspension is dried, and the rapid charging performance may be improved by lowering the resistance of the electrode surface.

The electrode slurry may further include a conductive material, a binder, a thickener, or a combination thereof, if necessary. The conductive material and the thickener may be the materials used in the binder suspension described above, and may be the same or different, but the disclosed technology is not limited thereto.

In some embodiments of the disclosed technology, the electrode active material layer may have a continuous concentration of the binder in the electrode thickness direction. In some implementations, the “continuous” distribution of the binder means that the binder suspension and the electrode slurry are not formed as separate layers, but the binder is continuous in the electrode active material layer, and thus, the concentration value of the binder is continuous in the thickness direction of the electrode active material layer.

According to the disclosed technology, the electrode may be a cathode or an anode.

When the electrode is a cathode, the electrode active material may be used without limitation as long as it is a cathode active material typically used in secondary batteries. For example, the electrode active material may include It may include any one cathode active material particle selected from the group consisting of LiCoO₂, LiNiO₂, LiMn₂O₄, LiCoPO₄, LiFePO₄, LiNiMnCoO₂, and LiNi_{1-x-y-z}CoₓM¹_{y}M²_{z}O₂ (M¹ and M² are each independently any one selected from the group consisting of Al, Ni, Co, Fe, Mn, V, Cr, Ti, W, Ta, and Mg, and x, y and z are each independently an atomic fraction of oxide composition elements and 0≤x<0.5, 0≤y<0.5, 0≤z<0.5, x+y+z≤1) or a mixture of two or more thereof.

When the electrode is an anode, the electrode active material may be used without limitation as long as it is an anode active material commonly used in secondary batteries. Examples of the anode active material may include a carbon-based anode active material, a silicon-based anode active material, or a mixture thereof, but is not limited thereto. The carbon-based anode active material may be one or more selected from artificial graphite, natural graphite, and hard carbon. The silicon-based anode active material is Si, SiOₓ (0<x<2), an Si-Q alloy (wherein Q is an element selected from the group consisting of alkali metal, alkaline earth metal, group 13 element, group 14 element, group 15 element, group 16 element, transition metal, rare earth element, and combinations thereof, and not Si), a Si-carbon composite, or a mixture of at least one of them and SiO₂.

Based on some embodiments of the disclosed technology, it is possible to provide an electrode having improved rapid charging performance of a secondary battery by lowering a binder content in the electrode and optimizing a binder distribution in the electrode.

In the electrode for a secondary battery based on some embodiments of the disclosed technology, a protruding height of the side portion of the electrode active material layer in the width direction may be 0 μm or less. When the side ring phenomenon is severe, there may be a problem in that the current collector is torn during winding during the electrode manufacturing process, or the electrode active material layer is dented by a rolling roll during rolling. In consideration of this, it is preferable that the protruding height of the side portion is lower. According to an example, the protruding height of the side portion of the electrode active material layer in the width direction may be 0 μm or less, or −0.2 μm or less, or −0.3 μm or less, or −0.5 μm or less.

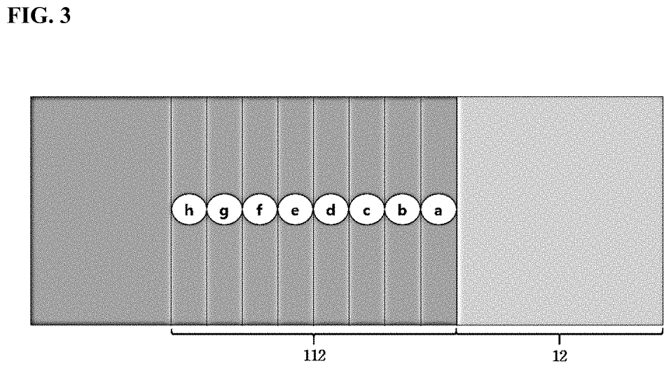

A method of measuring a protruding height of a side portion of an electrode active material layer in a width direction will be described in detail with reference to FIG. 3. Referring to FIG. 3, the protruding height of the side portion is obtained by dividing the side portion of the electrode active material layer into 8 equal parts in the width direction, and then measuring the thickness of the electrode at centers a to h of the 8 divided areas. In the three areas a to c sequentially from an outermost side to an inner side of the side portion in the width direction, the protruding height of the side portion is obtained by subtracting the average thickness value of the thicknesses of the electrodes measured in the remaining areas d to h other than the three areas from the highest thickness value among the measured thicknesses of the electrodes. The thickness of the electrode may be measured with a micrometer (Grade: 331-261-30) of Mitutoyo Co., with a diameter of 3 mm.

According to another exemplary embodiment of the disclosed technology, there is provided a method of manufacturing an electrode for a secondary battery including: a) applying a binder suspension to at least one surface of a current collector; b) drying a side portion of the current collector to which a binder suspension is applied; c) applying electrode slurry containing an electrode active material on the binder suspension; and d) drying a resultant of step c).

In step a), the current collector is prepared, and the binder suspension is applied to at least one surface of the current collector.

Types of the binder and solvent and the current collector are the same as described above. The known method may be applied as the method of preparing a binder suspension. For example, the binder suspension may be prepared by mixing a specific binder such as the SBR-based binder in a solvent and diluting the binder to have a suitable viscosity, but the disclosed technology is not limited thereto.

Step a) may be to uniformly apply the binder suspension to the entirety of at least one surface of the current collector. In some implementations, uniformly applying the binder suspension means uniformly applying the binder suspension on the current collector so that the binder does not form a specific pattern.

Based on some embodiments, in step a), the binder suspension may be applied to a thickness of 0.1 to 10 μm after drying. The application thickness of the binder suspension may be, for example, 0.5 to 5 μm, or 0.5 to 3 μm, or 0.5 to 1 μm. When the thickness of the applied binder suspension is excessive, the binder suspension is not well mixed with the electrode slurry, so, after the binder suspension is dried, the separation between the layers is clear and the binder layer, which is an insulator, is formed in the electrode active material layer, and thus, the interfacial specific resistance may be increased. On the other hand, when the application thickness of the binder suspension is less than 0.1 μm, it may be difficult to achieve the intended purpose of the disclosed technology. That is, it is possible to prevent an increase in interfacial specific resistance in the above-described thickness range, improve the interfacial adhesion between the current collector and the electrode active material layer, and improve process defects such as the detachment of the electrode.

Based on some embodiments, the binder suspension may include 5 to 50 wt %, 10 to 50 wt %, 15 to 50 wt %, 10 to 40 wt %, 10 to 40 wt %, or 15 to 40 wt %, 5 to 30 wt %, 10 to 30 wt %, or 15 to 30 wt % of binder based on the total weight of the binder suspension. The electrode slurry may include or may not include 2.0 wt % or less, 1.5 wt % or less, or 1.0 wt % or less of the binder, based on the total weight of the electrode slurry.

In step b), the side portion of the current collector applied with the binder suspension is dried. According to the exemplary embodiment of the disclosed technology, when drying the electrode active material layer to which the binder suspension-electrode slurry is sequentially applied in step d) following the drying in step b), the fluidity of the binder suspension in the side portion of the electrode is reduced, thereby solving problems occurring in the manufacturing process such as the side ring. In addition, it is possible to suppress the non-uniform distribution of the binder composition of the electrode in the width direction due to the difference in the migration rate of the binder in the side portion and the center portion of the electrode, thereby increasing the interfacial adhesion of the side portion of the electrode and improving the process defects such as the detachment of the electrode active material layer.

The drying time of step b) may be, for example, 0.001 to 5 seconds, 0.001 to 3 seconds, 0.001 to 2 seconds, 0.001 to 1 second, 0.005 to 5 seconds, 0.005 to 3 seconds, 0.005 to 2 seconds, 0.005 to 1 second, 0.015 to 5 seconds, 0.015 to 3 seconds, 0.015 to 2 seconds, 0.015 to 1 second, 0.03 to 5 seconds, 0.03 to 3 seconds, 0.03 to 2 seconds, or 0.03 to 1 second.

The drying temperature of step b) may be, for example, 120 to 600° C., 120 to 500° C., 120 to 450° C., 120 to 400° C., 150 to 600° C., 150 to 500° C., 150 to 450° C., 150 to 400° C., 200 to 600° C., 200 to 500° C., 200 to 450° C., or 200 to 400° C.

The drying time or drying temperature of step b) may be changed depending on the production rate of the electrode and the amount of binder applied. When the drying temperature is too high or the drying time is too long, not only the side portion but also the center portion may be dried or an insulating layer may be formed by excessive drying of the binder, which causes a problem in that the resistance of the electrode is increased. On the other hand, when the drying temperature is too low or the drying time is too short, the side portion is not sufficiently dried, so there is a risk of process defects such as the side ring. In an exemplary embodiment, the drying of step b) may be performed at a temperature of 120 to 600° C. for 0.001 to 5 seconds.

In step c), the electrode slurry containing the electrode active material is applied on the binder suspension. The electrode active material is the same as described above. As the method for preparing electrode slurry, any method known to be used for forming the known electrode slurry for a secondary battery may be used.

For the application of the binder suspension in step a) and the application of the electrode slurry in step c), any application method known to be used for forming a film by generally applying a liquid phase may be used. For example, spray coating, dip coating, spin coating, gravure coating, doctor blade coating, roll coating, inkjet printing, slot die coating, flexography printing, screen printing, electrostatic printing, micro contact printing, imprinting, reverse offset printing, bar-coating, gravi offset printing, etc., may be used, but is not limited thereto.

In step d), the resultant of step c) is dried.

The drying of step d) may be performed for 10 to 300 seconds, for example, 10 seconds or more, 20 seconds or more, or 30 seconds or more, for example, 300 seconds or less, 280 seconds or less, 260 seconds or less, 240 seconds or less, 220 seconds or less, 200 seconds or less, 180 seconds or less, 160 seconds or less, 150 seconds or less, 140 seconds or less, 130 seconds or less, 120 seconds or less, or 110 seconds or less.

In addition, the drying of step d) may be performed at a temperature of 50 to 300° C., for example, 50° C. or higher, 60° C. or higher, 70° C. or higher, 80° C. or higher, or 90° C. or higher, for example, 300° C. or lower, 280° C. or lower, 260° C. or less, 240° C. or lower, 220° C. or lower, or 200° C. or lower.

When the drying temperature of step d) is too high or the drying time is very short, the migration of the binder particles is excessive and interfacial adhesion may not be sufficiently implemented. In an exemplary embodiment, the drying of step d) may be performed at a temperature of 50 to 600° C. for 10 to 300 seconds.

Then, by rolling the dried electrode under appropriate conditions, an electrode having an electrode active material layer formed on the current collector may be manufactured. In this case, any known rolling method may be applied for the rolling, and the disclosed technology is not limited thereto.

In the method of manufacturing an electrode for a secondary battery based on some embodiments of the disclosed technology, the binder suspension containing a relatively large amount of binder is first applied, and then the electrode slurry that has a relatively small amount of binder contained on the upper portion of the binder suspension and contains a large amount of electrode active material is applied, so the binder may be densely distributed at the interface between the current collector and the electrode active material layer and in an area adjacent thereto. Accordingly, it is possible to suppress the detachment of the electrode active material layer and improve the rapid charging performance of the battery by lowering the binder content in the entire electrode active material layer.

In addition, in the method of manufacturing an electrode for a secondary battery according to the exemplary embodiment of the disclosed technology, when drying the electrode active material layer to which the binder suspension-electrode slurry of subsequent step d) through the step of drying the side portion of step b) is applied, it is possible to solve problems that occur in the manufacturing process, such as side rings by reducing the fluidity of the binder suspension in the side portion of the side ring. In addition, it is possible to suppress the non-uniform distribution of the binder composition of the electrode in the width direction due to the difference in the migration rate of the binder in the side portion and the center portion of the electrode, thereby increasing the interfacial adhesion of the side portion of the electrode and improving the process defects such as the detachment of the electrode active material layer.

Meanwhile, when the binder suspension is applied on the current collector without performing the above-described step b), in the case where the electrode may be manufactured by applying the binder suspension having a high binder content to the side portion and applying a binder suspension having a low binder content to the center portion, the manufacturing problem that requires two facilities to apply two different suspensions in the width direction may occur, when two suspensions are applied, a high difference may occur at the interface of the applied suspensions, or defects may occur due to non-coating.

Based on some embodiments of the disclosed technology, there is provided a secondary battery including the electrode according to the exemplary embodiment of the disclosed technology. The secondary battery may further include a separator and an electrolytic solution. The electrode is the same as described above.

The separator is not particularly limited as long as it is a known separation membrane in the art. For example, it may be selected from glass fiber, polyester, polyethylene, polypropylene, polytetrafluoroethylene, or a combination thereof, and may be in the form of a non-woven fabric or a woven fabric, and may optionally be used in a single-layer or multi-layer structure.

The electrolytic solution includes a non-aqueous organic solvent and an electrolytic solution salt. The non-aqueous organic solvent is ethylene carbonate (EC), propylene carbonate (PC), dimethyl carbonate (DMC), diethyl carbonate (DEC), ethylmethyl carbonate (EMC), 1,2-dimethoxyethane (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO), acetonitrile (AN), or a mixture thereof, but is not limited thereto. The electrolytic solution salt is a material that is dissolved in the non-aqueous organic solvent, and thus, serves as a source of electrolytic metal ions in the battery to enable basic secondary battery operation, and promote the movement of electrolytic metal ions between the cathode and the anode. As a non-limiting example, when the electrolytic metal is lithium, the electrolytic salt is LiPF₆, LiBF₄, LiTFSI, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (however, x and y are natural numbers), LiCl, LiI, or a mixture thereof, but is not limited thereto. In addition, the electrolytic solution salt may use the known material in a concentration suitable for the purpose, and if necessary, may further include the known solvent or additive to improve charging/discharging characteristics, flame retardancy characteristics, and the like.

In the method for manufacturing a lithium secondary battery according to the disclosed technology for achieving the above object, the battery may be manufactured by forming an electrode assembly by sequentially stacking a manufactured anode, a separator, and a cathode, putting the manufactured electrode assembly in a cylindrical battery case or a prismatic shape, and then injecting an electrolytic solution. Alternatively, the battery may be manufactured by stacking the electrode assembly, impregnating the electrode assembly in the electrolytic solution, and putting and sealing the obtained resultant in a battery case.

For the battery case used in the disclosed technology, those commonly used in the field may be adopted, and there is no limitation in the appearance according to the use of the battery. For example, a cylindrical type using a can, a prismatic type, a pouch type, a coin type, etc., may be used.

The secondary battery according to the disclosed technology may be used not only in a battery cell used as a power source for a small device, but also may be preferably used as a unit cell in a medium-large battery module including a plurality of battery cells. Preferred examples of the medium-large device include, but are not limited to, an electric vehicle, a hybrid electric vehicle, a plug-in hybrid electric vehicle, a system for power storage, etc., but are not limited thereto.

Hereinafter, the disclosed technology will be described in detail by way of examples, but these are for describing the disclosed technology in more detail, and the scope of the disclosed technology is not limited by the following examples.

### EXAMPLES

### Example 1

Manufacturing of Anode

A binder suspension may be prepared by diluting an SBR (Zeon BM451B) suspension as a binder and a CMC thickener with pure water so that the SBR suspension and the CMC thickener are a weight ratio of 99:1.

An anode active material in which artificial graphite (D50:13 μm) and natural graphite (D50:10 μm) are mixed in a weight ratio of 5:5, a CMC thickener, and an SBR binder may be added to water in a weight ratio of 98.5:1:0.5 to prepare an anode slurry having a viscosity of 5,000 cps.

The binder suspension prepared on one surface of a copper current collector (copper foil with a thickness of 8 μm) may be applied to a thickness of 1 μm by a gravure coating method, and then side portions on both sides of the copper current collector in the width direction to which the binder suspension may be applied may be dried. The prepared anode slurry may be applied to a thickness of 83 μm using a slot die, dried, and the binder suspension and anode slurry may be applied to another surface in the same manner and dried. In this case, the drying may be performed under the conditions described in Table 1 below. After the drying, the rolling (rolling density: 1.68 g/cm³) may be performed to manufacture an anode with an anode active material layer formed thereon.

In this case, the anode used an electrode having a width of 100 mm based on an electrode coated part, and the side portion may be an area of 20 mm in width at an end portion in the width direction, and the center portion may be an area of 80 mm in width excluding the side portion.

Manufacturing of Cathode

A slurry may be prepared by mixing Li[Ni_{0.88}Co_{0.1}Mn_{0.02}]O₂ as a cathode active material, carbon black as a conductive material, and polyvinylidene fluoride (PVDF) as a binder in a weight ratio of 96.5:2:1.5. The slurry may be uniformly applied to an aluminum foil having a thickness of 12 μm, and vacuum-dried to manufacture a cathode for a secondary battery.

Manufacturing of Secondary Battery

The cathode and the anode are each stacked by notching to a predetermined size, and a separator (polyethylene, thickness of 13 μm) is disposed between the cathode and the anode to form an electrode cell, and then each tab portion of the cathode and the anode may be welded. The assembly of the welded cathode/separator/anode may be put in a pouch, and three sides may be sealed except for an electrolytic solution injection side. In this case, the part with the electrode tab may be included in the sealing part. An electrolytic solution may be injected through the remaining surfaces except for the sealing part, and the remaining surfaces may be sealed and then impregnated for 12 hours or more. As the electrolytic solution, after 1M LiPF₆ is dissolved in a mixed solvent of EC/EMC/DEC (25/45/30; volume ratio), those to which 1 wt % of vinylene carbonate (VC), 0.5 wt % of 1,3-propanesultone (PRS), and 0.5 wt % of lithium bis(oxalato)borate (LiBOB) based on a total weight of electrolytic solution are added may be used.

Thereafter, pre-charging may be performed for 36 minutes with a current corresponding to 0.25 C. After degassing is performed after 1 hour and aging is performed for more than 24 hours, chemical charge and discharge may be performed (charging condition CC-CV 0.2 C 4.2V 0.05 C CUT-OFF, discharging condition CC 0.2 C 2.5V CUTOFF).

Thereafter, standard charging and discharging may be performed (charging condition CC-CV 0.33 C 4.2V 0.05 C CUT-OFF, discharging condition CC 0.33 C 2.5V CUT-OFF).

### Examples 2 and 3, and Comparative Examples 1 to 3

Examples 2 and 3 and Comparative Examples 1 to 3 may be performed under the same manufacturing conditions as in Example 1, except that the conditions for drying the side portion during the manufacturing of the anode may be performed under the conditions described in Table 1.

In Table 1 below, the drying was performed with a hot air blower in consideration of the drying conditions such as temperature.

The binder content may be derived by sufficiently exposing the electrode to Os gas and then using the content (at %) of the adsorbed Os element, and Bₑᵢ/B_{ci} and Bₑᵢ/Bₑₛ may be derived by utilizing the binder content and the contents described in Relational Expressions 1 and 2 discussed above.

Here, B_{ci} is the interfacial binder content of the center portion of the electrode active material layer in the width direction, Bₑᵢ is the interfacial binder content of the side portion of the electrode active material layer in the width direction, and Bₑₛ is the surface binder content of the side portion of the electrode active material layer in the width direction, and each binder content may be measured through the method described above and then calculated to derive each value.

The “protruding height of the side portion” in Table 1 is the protruding height of the side portion of the electrode active material layer in the width direction, and may be measured according to the method for measuring a protruding height of a side portion in a width direction based on some embodiments of the disclosed technology. The thickness of the electrode may be measured with a micrometer (Grade: 331-261-30) of Mitutoyo Co. with a diameter of 3 mm.

In Table 1, “whether imprinting occurred” may be evaluated as dent if the number of times of dent on the electrode may be 3 times or more due to detachment of electrode active material particles during a 200 m rolling running at a speed of 20 m/min with a roll-to-roll press machine.

TABLE 1

| | Drying condition | | | | Protruding | |
|---|---|---|---|---|---|---|
| | of side portion | | Binder | | height | Whether |
| | Whether to | Tem- | distribution | | of side | dent |
| | perform | perature | Bₑᵢ/ | Bₑᵢ/ | portion | occurs |
| | (○/x) | (° C.) | B_{ci} | Bₑₛ | (μm) | (○/x) |
| Example 1 | ○ | 200 | 1.26 | 3.16 | −0.7 | x |
| Example 2 | ○ | 500 | 1.34 | 3.22 | −1.0 | x |
| Example 3 | ○ | 400 | 1.39 | 3.18 | −3.2 | x |
| Comparative | x | — | 0.71 | 2.15 | 15.6 | ○ |
| Example 1 | | | | | | |
| Comparative | ○ | 50 | 0.82 | 1.95 | 2.6 | ○ |
| Example 2 | | | | | | |
| Comparative | ○ | 100 | 0.73 | 1.89 | 2.7 | ○ |
| Example 3 | | | | | | |

The “electrode adhesion” in Table 2 below may be measured between the anode active material layer of the manufactured anode and the anode current collector with an adhesion measurement device (TMADA DS2-50N) of an electrode substrate. In the measurement method, after a double-sided tape may be attached to an adhesion measuring jig and the manufactured anode current collector may be positioned on the tape, the roller reciprocates the manufactured anode current collector 10 times to attach the anode current collector. Thereafter, the tape may be cut to a width of 18 mm and attached to the center portion of the measuring jig with the tape side facing down. Thereafter, the adhesion to the anode active material layer may be measured while moving the adhesion measuring device at a speed of 300 rpm in a direction perpendicular to 90° of an adhesive surface.

The “interfacial specific resistance” of Table 2 below may be measured by applying a measurement current of 10 mA to the manufactured anode with an electrode resistance measuring device of XF057 battery from HIOKI Co.

For “cell resistance (DC-IR)” in Table 2 below, the cell resistance of the manufactured secondary battery may be measured. The cell resistance may be measured by the following method. The manufactured secondary batteries of each Example and Comparative Example may be charged (0.3 C CC/CV charge 4.2V 0.05 C cut), rested for 10 minutes, and discharged (0.3 C CC discharge SOC50 cut). The secondary battery may be rested for 1 hour at SOC50, 1 C discharged for 10 seconds, and then rested for 10 seconds again. In this case, the cell resistance (DC-IR) may be calculated by dividing a difference between a voltage after resting at the SOC50 for 1 hour and a voltage after the 1 C discharge for 10 seconds by a current.

TABLE 2

| | | | Interfacial specific | | |
|---|---|---|---|---|---|
| | Electrode adhesion | | resistance | | Cell |
| | (N/cm) | | (Ω · cm²) | | resistance |
| | Center | Side | Center | Side | DC-IR |
| | portion | portion | portion | portion | (mΩ) |
| Example 1 | 0.22 | 0.31 | 0.018 | 0.016 | 1.34 |
| Example 2 | 0.21 | 0.24 | 0.02 | 0.019 | 1.33 |
| Example 3 | 0.22 | 0.33 | 0.014 | 0.014 | 1.31 |
| Comparative | 0.22 | 0.16 | 0.013 | 0.013 | 1.35 |
| Example 1 | | | | | |
| Comparative | 0.21 | 0.17 | 0.019 | 0.02 | 1.36 |
| Example 2 | | | | | |
| Comparative | 0.20 | 0.16 | 0.016 | 0.018 | 1.33 |
| Example 3 | | | | | |

The results of Tables 1 and 2 are compared and evaluated. Referring to Tables 1 and 2, in Examples 1 to 3 of the disclosed technology, the protruding height of the side portion may be 0 μm or less, and the electrode active material layer may not detach, so no dents occurred during the rolling.

On the other hand, in Comparative Example 1, the drying of the side portion is not performed, and when the entire electrode active material layer of the binder suspension-anode slurry is dried, the side portion is dried rapidly, and the migration of the binder in the side portion is more actively performed compared to the center portion. As the migration rate of the binder is different in the side portion and the center portion, the binder distribution in the electrode active material layer becomes non-uniform. As a result, the Bₑᵢ/B_{ci} value may be less than 1.0, and the Bₑᵢ/Bₑₛ value may be less than 2.5, so the adhesion between the electrode active material layer and the current collector may be reduced in the side portion. In addition, the protruding height of the side portion may greatly exceed 0 μm, and many particle dents may occur during the rolling.

Comparative Examples 2 and 3 dried the side portion, but the drying temperature is lower than the temperature limited by some embodiments of the disclosed technology. As a result, the side portion is not dried sufficiently, so the Bₑᵢ/B_{ci} value may be less than 1.0, and the Bₑᵢ/Bₑₛ value may be less than 2.5, so the adhesion between the electrode active material layer and the current collector may be reduced in the side portion. In addition, the side portion may not be sufficiently dried, so the protruding height of the side portion may exceed 0 μm, and many particle dents may occur during the rolling.

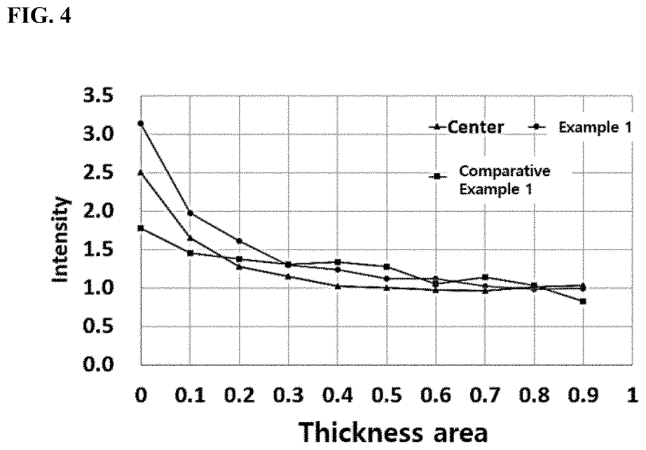

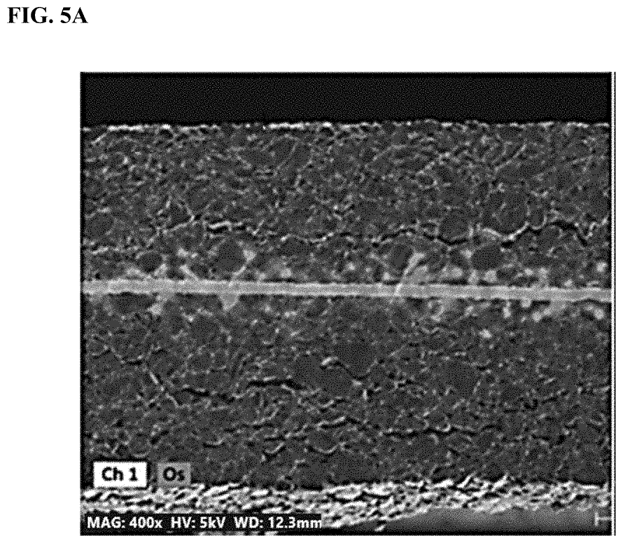

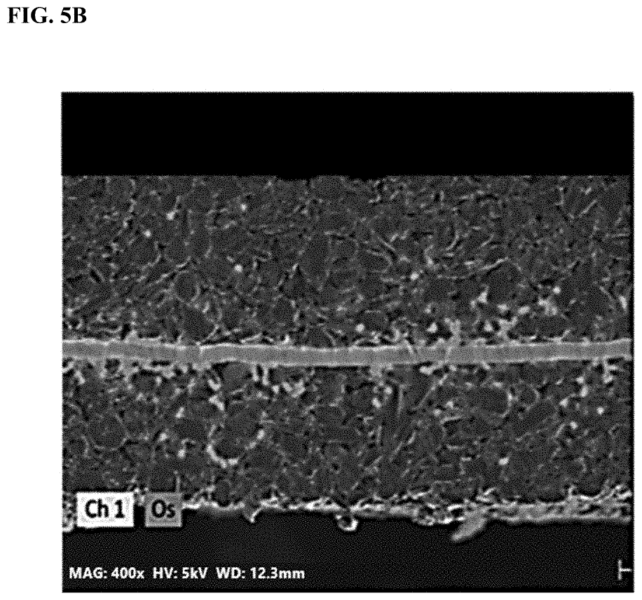

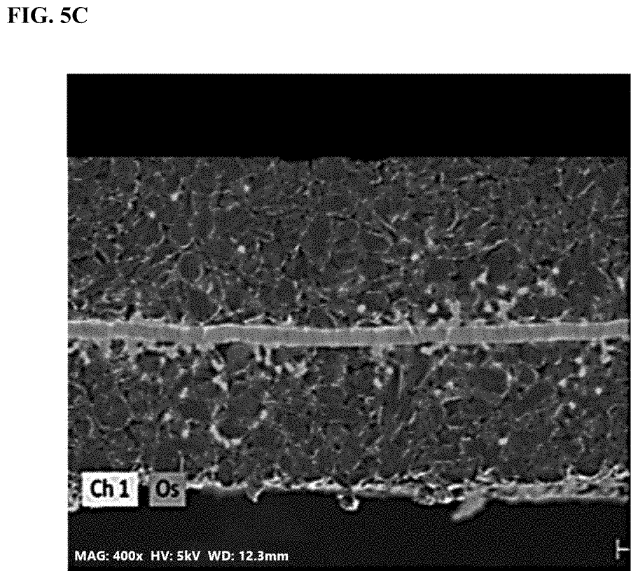

FIGS. 4 and 5A to 5C are graphs reflecting the results of EDS analysis for evaluating the binder distribution in the thickness direction according to whether to dry the side portion, and EDS mapping images. For the EDS analysis, the manufactured electrode may be sufficiently exposed to Os gas, and then the analysis may be performed on the Os element.

FIG. 4 is a graph reflecting results of EDS analysis for evaluating a binder distribution in a thickness direction according to whether to dry the side portion of the electrode. In FIG. 4, a line of “Example 1” indicates the distribution of the binder content of the side portion of Example 1 in the thickness direction, and a line of “Comparative Example 1” indicates the distribution of the binder content of the side portion of Comparative Example 1 in the thickness direction. A line of “center” indicates the binder content distribution of the center portion of Example 1 in the thickness direction. Since the line of the “Center” has little change in the distribution of binder content depending on whether the drying of the side portion is performed, the distribution of the binder content of the side portion of Example 1 and Comparative Example according to whether the drying of the side portion is performed may be evaluated by utilizing the distribution of the binder content of the center portion of Example 1 in the thickness direction. In a horizontal axis ‘thickness area’ of the graph of FIG. 4, “0” may be the interface between the current collector and the electrode active material layer, and “1” may be the surface of the electrode active material layer, so the binder distribution may be indicated in the thickness direction from the interface to the surface. A vertical axis “Intensity” of the graph of FIG. 4 is an index for evaluating the relative amount of the binder content, and indicates the EDS intensity for the Os element. The higher the intensity value, the higher the binder content in the corresponding thickness area.

Referring to FIG. 4, in Example 1, the interfacial binder content B_{ci} of the side portion may be higher than the interfacial binder content B_{ci} of the center portion, and adhesion between the current collector and the electrode active material layer of the side portion may be measured to be higher than that in the center portion. On the other hand, in Comparative Example 1, the interfacial binder content B_{ci} of the side portion may be lower than the interfacial binder content B_{ci} of the center portion, so the adhesion between the current collector and the electrode active material layer of the side portion may be measured to be lower than the adhesion in the center portion. As a result, the risk of detachment of the electrode active material layer during the assembly process of the secondary battery or the cycle evaluation of the secondary battery may be relatively high.

FIGS. 5A to 5C are diagrams illustrating EDS mapping images for evaluating a binder distribution in the thickness direction according to whether to dry the side portion. FIG. 5A is an EDS mapping image in which the interfacial binder content of the center portion is measured, FIG. 5B is an EDS mapping image in which the interfacial binder content of the side portion of Comparative Example 1 is measured, and FIG. 5c is an EDS mapping image in which the interfacial binder content of the side portion of Example 1 is measured. Referring to FIG. 5C among the accompanying drawings, it can be visually confirmed that the interfacial binder content of the side portion is high in the case of Example 1 in which the drying of the side portion is performed.

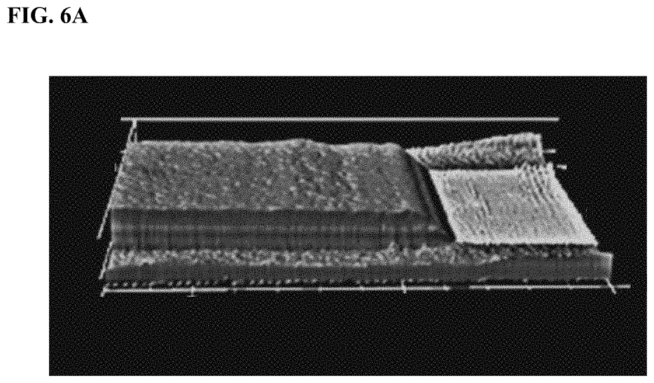

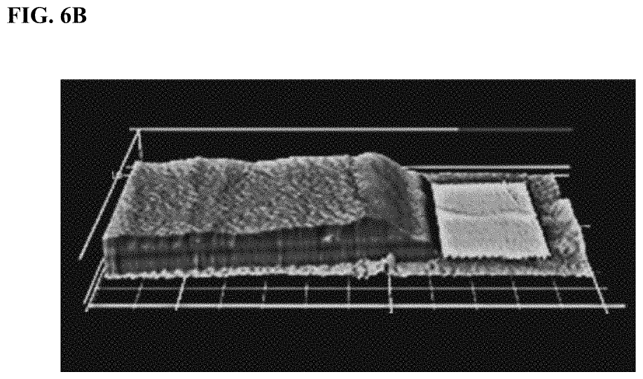

FIGS. 6A and 6B are 3D images obtained by analyzing the cross section of the anode in the width direction according to Example 1 and Comparative Example 1. Referring to FIGS. 6A and 6B, in Comparative Example 1 compared to Example 1, it may be visually confirmed that the thickness of the side portion of the anode is significantly thicker than the thickness of the center portion.

In some embodiments of the disclosed technology, it is possible to provide an electrode having improved rapid charging performance of a secondary battery by lowering a binder content in the electrode and optimizing a binder distribution in the electrode.

The method of manufacturing an electrode for a secondary battery based on some embodiments of the disclosed technology includes applying a binder suspension containing a relatively large amount of binder, drying a side portion of a current collector to which the binder suspension is applied, and applying electrode slurry containing a large amount of electrode active material. Accordingly, it is possible to solve problems that occur in a manufacturing process, such as side rings by solving problems of a non-uniform thickness and a non-uniform distribution of a binder composition in a width direction of an electrode due to a difference in a migration rate of the binder at a side portion and a center portion of the electrode when drying an electrode active material layer in which a binder suspension-electrode slurry is sequentially applied.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to, in addition to improving the rapid charging performance, address various adverse effects such as air pollution and greenhouse emissions by powering electric vehicles (EVs) as alternatives to vehicles using fossil fuel-based engines and by providing battery based energy storage systems (ESSs) to store renewable energy such as solar power and wind power.

What is claimed is:

1. An electrode for a secondary battery, comprising:
a current collector; and
an electrode active material layer located on at least one surface of the current collector, wherein the electrode active material layer satisfies the following relational expression:
1.0≤Bₑᵢ/B_{ci}≤2.0,
wherein B_{ci} is an interfacial binder content of a center portion of the electrode active material layer in a width direction of the electrode active material layer, and Bₑᵢ is an interfacial binder content of a side portion of the electrode active material layer in the width direction of the electrode active material layer.

2. The electrode of claim 1, wherein the electrode active material layer further satisfies the following relational expression:
2.5≤Bₑᵢ/Bₑₛ≤5.0
wherein Bₑₛ is a surface binder content of the side portion of the electrode active material layer in the width direction of the electrode active material layer, and Bₑᵢ is an interfacial binder content of the side portion of the electrode active material layer in the width direction of the electrode active material layer.

3. The electrode of claim 1, wherein the electrode active material layer includes 0.1 to 2 wt % of binder based on a total weight of the electrode active material layer.

4. The electrode of claim 1, wherein the electrode active material layer includes a styrene butadiene rubber-based binder.

5. The electrode of claim 1, wherein the electrode includes an anode.

6. The electrode of claim 1, wherein a protruding height of the side portion of the electrode active material layer in the width direction is 0 μm or less.

7. A method of manufacturing an electrode for a secondary battery, comprising:
applying a binder suspension to at least one surface of a current collector;
drying a side portion of the current collector to which the binder suspension is applied;
applying electrode slurry containing an electrode active material onto the binder suspension; and
drying the binder suspension onto which the electrode slurry containing the electrode active material is applied.

8. The method of claim 7, wherein applying the binder suspension to the at least one surface of the current collector includes uniformly applying the binder suspension to at least one surface of the current collector.

9. The method of claim 7, wherein the binder suspension applied to the at least one surface of the current collector has a thickness ranging from 0.1 μm to 10 μm.

10. The method of claim 7, wherein the binder suspension applied to the at least one surface of the current collector includes 5 to 50 wt % of the binder based on a total weight of the binder suspension, and
the electrode slurry applied onto the binder suspension includes a binder in an amount of 2.0 wt % or less based on the total weight of the electrode slurry.

11. The method of claim 7, wherein the drying of the at least one side portion of the current collector to which the binder suspension is applied is performed for 0.001 to 5 seconds at a temperature of 120 to 600° C.

12. The method of claim 7, wherein the drying of the binder suspension onto which the electrode slurry containing the electrode active material is applied is performed for 10 to 300 seconds at a temperature of 50 to 300° C.

13. A secondary battery comprising:
an electrode for a secondary battery, comprising:
a current collector; and
an electrode active material layer located on at least one surface of the current collector,
wherein the electrode active material layer satisfies the following relational expression:
1.0≤Bₑᵢ/B_{ci}≤2.0,
wherein B_{ci} is an interfacial binder content of a center portion of the electrode active material layer in a width direction of the electrode active material layer, and Bₑᵢ is an interfacial binder content of a side portion of the electrode active material layer in the width direction of the electrode active material layer.

14. The secondary battery of claim 13, wherein the electrode active material layer further satisfies the following relational expression:
2.5≤Bₑᵢ/Bₑₛ≤5.0
wherein Bₑₛ is a surface binder content of the side portion of the electrode active material layer in the width direction of the electrode active material layer, and Bₑᵢ is an interfacial binder content of the side portion of the electrode active material layer in the width direction of the electrode active material layer.

15. The secondary battery of claim 13, wherein the electrode active material layer includes 0.1 to 2 wt % of binder based on a total weight of the electrode active material layer.

16. The secondary battery of claim 13, wherein the electrode active material layer includes a styrene butadiene rubber-based binder.

17. The secondary battery of claim 13, wherein the electrode includes an anode.

18. The secondary battery of claim 13, wherein a protruding height of the side portion of the electrode active material layer in the width direction is 0 μm or less.
